(19) United States
(12) Patent Application Publication
(10) Pub. No.: US 2023/0406132 A1
(43) Pub. Date: Dec. 21, 2023

(54) System and method for charging vehicles, a charging module for vehicles thereof and method for storing vehicles

(71) Applicant: STRIM MOBILITY SAS, Strasbourg (FR)

(72) Inventors: Sergey PISARENKO, Moscow (RU); Vasilii BYKOV, Moscow (RU); Denis MEDVEDEV, SAINT-PETERSBURG (RU)

(21) Appl. No.: 18/028,748

(22) PCT Filed: Sep. 25, 2020
(86) PCT No.: PCT/EP2020/000164

§ 371 Date: Mar. 27, 2023

(51) Int. Cl. B60L 53/62; B60L 53/16; B60L 53/65; B60L 53/18

(52) U.S. Cl. CPC B60L 53/62; B60L 53/16; B60L 53/65; B60L 53/18; B60L 2200/12; B60L 2200/24

(57) ABSTRACT

A family of inventions relates to charging and renting vehicles, including (light) personal mobility vehicles, and can be used to build up transport networks within urban areas, enterprises and other territories. Technical result for the accomplishment of which this family of inventions is directed at consists in making it possible to connect variable batteries of numerous vehicles simultaneously to a charging system with subsequent charging thereof at once. The concept of this family of inventions comprises a vehicle charging module provided with means for receiving and transmitting electrical energy, which differs from the prototype in that said module is configured to be able to specify electrical characteristics of vehicle power components (batteries) and to convert electrical characteristics of the current received in those required for the charging of vehicle batteries in accordance with its electrical characteristics, 4 independent primary claims, 21 dependent claims, 11 figures.

A family of inventions relates to systems for charging and renting vehicles including smaller vehicles (transporters) of personal mobility and can be utilized to build up transport networks within urban areas, enterprises and other territories.

A system for charging electric bicycle batteries with a charging station and an electric bicycle with a charge terminal integrated in a steer tube wherein the charging station is equipped with a charging cable for connecting and charging the electric bike and the charging terminal has a mount hole for connecting the charging cable of the station is known for those skilled in the art [KR20120010156, published 2 Feb. 2012, IPC: B62H 3/02, B62H 5/00, B62H 5/20].

The known charging system suffers from its restricted functionality exhibiting an impossibility to rapidly refit and modify an electric bicycle to be used with the system since every time it is required to dismantle the charging terminal from the steer tube of the electric bike and replace it with another one. Furthermore said charging station will not allow using one and the same slot (or cable) for charging numerous kinds of electric vehicles except for the bicycles.

Those skilled in the art know a system for charging electric scooters (segways) supplied with a charging station and an electric scooter with a charging module mounted thereon wherein the charging station is provided with a socket for connecting and charging an electric scooter (segway) and the charging module is equipped with a plug for connecting the charging station thereto and a plug for connecting an electric scooter to a battery [US2020031247, published 30 Jan. 2020, IPC:B60L 53/31, B60L 53/53, B60L 53/62].

An advantage of the known system is that it has broader functionality associated with the use of the charging module configured to rapidly refit an electric scooter with the same structure for its use with this system. However a disadvantage of the known system is its constrained functionality as long as charging a great number of electric scooters will require more charging stations therefore it will be quite difficult to locate the system within confined space of urban areas with their compact planning and high population density. In addition, limited number of points for connecting scooters does not make it easy to use the system since consumers cannot leave their scooters at a chosen station because of its busyness. Thus, in conditions of busy urban traffic this system will not be flexible enough to adapt to peak demand and to provide one group of consumers with sufficient number of parking lots for electric scooters, and the other one with an adequate supply of accessible scooters in most handy places.

As a prototype we have chosen a system for charging electrically-driven scooters comprising a charging station and an electric scooter with a charging module installed thereon, wherein the station has a magnetic electrical connector to transmit electrical energy to batteries of the electric scooter, the charging module with the magnetic electrical connector to receive electrical energy and an electric magnetic connector to transmit electrical energy, the charging station is configured to recognize a novel scooter connected to a charging circuit and to transmit electrical energy to its charging module to charge its batteries[WO2019135043, published 11 Jul. 2019 r., IPC: B60L 53/16, B60H 3/00, B62K 3/00].

An advantage of the prototype is the provision of a highly compact system with a large number of scooters used therein due to their rigid coupling with magnetic electrical connectors among each other and the possibility of charging from the same charging station. However, the disadvantage of the prototype is impossibility to simultaneously charge variable batteries of numerous vehicles with variable overall and electrical characteristics, mounted on different levels. This disadvantage is due to the fact that the magnetic electrical connectors provide only a rigid coupling of vehicles with no possibility in their free spatial orientation relative to one another, wherein for coupling vehicles with magnetic electrical connectors in a chain, the connectors must be installed on the same level (at a certain angle and at a certain distance), and vehicles and batteries must be of the same type and have a similar frame or body configuration, therefore, the coupling of a children's single-seat electric car and a scooter at the same time, or a “Segway”, or a mono-wheel will be impossible, and accordingly, it will not be possible for consumers to charge their vehicles with electrical energy, such as, i.e. a headlight or a lock for blocking conventional non-electric vehicles. Also, this disadvantage is due to the fact that each charging station is designed to charge a certain type of electric vehicles and contains data of current characteristics in accordance with a chain of vehicles for which it is originally applied, and an attempt to connect and charge a vehicle other than that which is already in the chain, can lead to electrical damage of the charging station, or the connected electric vehicles, or vehicles in the chain, which collectively significantly limits the functionality of the system for charging electric vehicles.

The technical problem to be solved by the family of inventions is the need to expand the functionality and application scope of the system for charging vehicle batteries.

The technical result, at which the family of inventions is directed, is to provide the possibility of simultaneous connection to the system for charging and subsequent simultaneous charging of variable types of batteries of a great number of vehicles.

A further technical result, at which the family of inventions is directed, is to provide blocking of numerous types of vehicles due to a locking gear installed in the socket of the charging module.

A further technical result, at which the family of inventions is directed, is to reduce the risk of failure of the charging station due to the use of an electric power converter located in the charging module for charging the vehicle battery.

A further technical result, at which the family of inventions is directed, is to reduce the risk of failure for the charging module due to the use for the battery charge of the vehicle of the electronic components of the vehicle on which the charging module is installed.

A yet another technical result, at which the family of inventions is directed, is to reduce the risk of failure of the vehicle as a result of increasing the accuracy of determining the required electrical characteristics of the current for charging the batteries installed on the vehicle.

An even still another technical result, at which the family of inventions is aimed, is to improve the quality of the system operation due to the possibility of automatic start of charging the vehicle battery when it is docked with the charging station with no need in a wireless connection with a system remote server and in reception of additional commands from it.

The concept of the first invention from the family of inventions is as follows.

The system for charging vehicles consists of a charging station and a vehicle, wherein the charging station comprises means for transmitting electrical energy to a battery of a vehicle, and the vehicle comprises a charging module equipped with a means for receiving electrical energy and a means for transmitting electrical energy to a battery of a third-party vehicle. Unlike the prototype, the means for receiving electrical energy of the charging module is represented by a cable with an electrical connector, and the charging station or charging module is configured to obtain the electrical characteristics of the vehicle battery and convert the electrical characteristics of the resulting current into those required for charging the battery in accordance with its electrical characteristics.

The concept of the second invention from the family of inventions is as follows.

The vehicle charging module is provided with a means for receiving electrical energy and a means for transmitting electrical energy to a battery of a third-party vehicle. In contrast to the prototype, the means for receiving electrical energy is represented by a cable with an electrical connector, and the charging module is configured to obtain electrical characteristics of the vehicle battery and convert the electrical characteristics of the resulting current into those required for charging the vehicle battery in accordance with its electrical characteristics.

The concept of the third invention from the family of inventions is as follows.

A method for charging vehicles includes transmittance of electrical energy by the charging station to the vehicle battery through a means for transmitting electrical energy of the charging station, the charging module receiving electrical energy from the charging station through the equipment for receiving electric power from the vehicle charging module, and subsequent transmittance of the received electrical energy by the charging module to a third-party vehicle battery through a means of receiving electrical energy by the charging module of a third-party vehicle connected to a means for transmitting electrical energy. In contrast to the prototype, electrical energy is received by the charging module through a cable with an electrical connector, while the charging module obtains the electrical characteristics of the vehicle battery and converts the electrical characteristics of the received current into those required for charging the battery vehicle in accordance with its electrical characteristics.

The concept of the fourth invention from the family of inventions is as follows.

A method for storing vehicles, comprising: connecting a means for receiving electrical energy of a charging module of a vehicle with a means for transmitting electrical energy of a charging station and then connecting the means for receiving electrical energy of a charging module of a third-party vehicle with the means for transmitting electrical energy of a charging module of a vehicle, wherein the means for receiving electrical energy of the charging module uses a cable with an electrical connector, and when connecting the electrical connector to the means for transmitting electrical energy of the charging station or charging module, the spatial position of the electrical connector is registered by the means for transmitting electrical energy of the charging station or charging module.

The system for charging vehicles provides the ability to temporarily store this vehicle in order to replenish the charge rate of its batteries, as well as to protect it from unauthorized operation of the vehicle, as well as to provide vehicles for temporary use, including on the basis of a rental to the user, for example, through a specialized application downloaded by the user's electronic device or through any other access control systems with electronic cards or electronic tickets. The vehicle can be an electric or non-electric single-track, two-track or three-track electric vehicle. In this case, a single-track vehicle can be represented by a one-wheeled or more than one-wheeled vehicle, including a mono-wheel, a scooter, a bicycle, a motorcycle, etc. A two-track vehicle can be represented by a two-wheeled or more than two-wheeled vehicle, including a “Segway” gyro scooter, ATV or a car. A three-track vehicle can be a tricycle, as well as cars or other vehicles with a similar chassis configuration. As a vehicle battery, an electric drive battery for an electric vehicle and/or a battery for lighting devices or an electric lock of an electric/non-electric vehicle, etc. can be presented. To identify a vehicle with the charging station, it may contain a radio frequency tag or a sticker with graphic information in the form of a QR or bar code, or a chip transmitting an identification number when the vehicle is connected to a charging station or another vehicle. In this case, the transport may be provided with wireless communication, represented by Wi-Fi, 5G, GSM, Bluetooth or other devices which meet radio standards.

The charging station converts electrical characteristics of the current received from electrical networks of general purpose and from storage batteries, into those required for charging a vehicle battery and transmitting electrical energy to one or more units of batteries attached to numerous vehicles. To do this, the charging station may contain a charging station controller configured to receive data on the battery charge rate of the vehicle from the charging modules by using specialized software, or the charging station may contain a wireless communication device represented by W-Fi, GSM or Bluetooth modules connected to the controller and configured to connect to a remote server of the system to obtain data on the sequence of charging the vehicle batteries. In this case, the charging station controller can be configured to download specialized software for charging a vehicle battery from a remote server or data exchange with this server in relation to each connected vehicle battery. In this case, to convert electrical characteristics of the current into those required for charging the vehicle battery, the charging station may comprise an electrical converter of the charging station connected to the controller with the possibility of receiving commands from specialized software for setting the required current characteristics and charging the vehicle battery. The charging station may contain a device to recognize vehicle batteries connected to it by obtaining a unique identification number of the vehicle connected to the controller, or by radio frequency identification of the radio tag installed on the vehicle. The charging station can be configured to exchange data with transport by means of a module for transmitting and reading information via a cable with an electrical connector, through which the charge is directly transmitted, or via a separate wire or by wireless communication equipment.

The means for transmitting electrical energy to the battery of a vehicle enables the battery to be charged from the charging station. The means for transmitting electrical energy can be connected to the controller and/or the electrical converter of the charging station with the possibility of receiving electric current therefrom for charging the battery of the vehicle. The means for transmitting electrical energy can be represented by a socket or an electrical connector with contacts for charging the vehicle, configured in accordance with the electrical connector installed onto the cable of the charging module. In this case, the socket may contain a locking (holding) element providing blockage of the electrical connector to prevent possibility of unauthorized operation of the vehicle and to ensure its reliable storage and issuance only to authorized users or by reading identification cards, passes or electronic tickets.

The charging station may include a housing configured to mount and protect the electronic components of the charging station, or these electronic components can be mounted, for example, inside building walls, improvement elements, public transport stops, subway entrances, street lighting poles and other structures with no need to install the charging station in the ground or road surface.

The vehicle battery charging module may be built into a vehicle or additionally installed on it and configured to charge several batteries from the same charging station by transmitting electrical energy from the charging module of the same vehicle connected to the charging station to the charging module of another vehicle. Moreover, the latter eliminates the need for direct connection of such a third-party vehicle to the charging station. For this purpose, the charging module contains a means for receiving electrical energy in the form of a cable with an electrical connector configured to connect the charging module to a means for transmitting electrical energy of the charging station or to a means for transmitting electric energy of another charging module, and also contains a means for transmitting electrical energy to a battery of a third-party vehicle. In this case, the charging module can be configured to activate a channel to create a closed loop between the charging station and another charging module, providing the possibility of a loop-through connection with the charging station and charging the batteries of several vehicles individually from the same charging station of the system.

The charging module is configured to obtain the electrical characteristics of the vehicle battery and convert the electrical characteristics of the current into those required for charging the vehicle battery in accordance with its electrical characteristics, which makes it possible to simultaneously charge the vehicle battery cells with variable electrical characteristics by the system, and also reduce the risk of electric damage to the charging station and the vehicle during charging, thus providing the possibility of simultaneous charging vehicle batteries with variable supply voltages by the system. The charging module may comprise an interface for connecting to a vehicle, providing the possibility of electrical connection with its on-board network to determine the electrical characteristics of its battery, as well as with electronic components of an electric vehicle, including a control unit, an electrical converter, wireless communication and other vehicle components to interact therewith (if any). The interface can be represented by an electrical connector or by wireless data transmission equipment. The interface can also be represented by a control panel, and/or an information output panel, and/or a panel for reading electronic passes or electronic disposable/reusable tickets, and/or equipment for entering a pin code, equipment for accepting plastic payment cards, equipment for remote contactless payment (for example, SamsungPay, ApplePay or similar).

The charging module can be configured to exchange data with the charging station and other charging modules directly via the cable, both through conductive wires, and through additional wires intended only for data transmission, as well as through wireless communication transmitting information via Wi-Fi channels, 5G, GSM or Bluetooth, etc.

Obtaining electrical characteristics of the vehicle power supply is provided by the controller of the charging module and makes it possible to obtain data on the voltage, type and capacity of batteries, their current charge rate, self-diagnostics results, etc. For this, the charging module controller can be electrically connected to the interface. To obtain electrical characteristics of the current for charging a vehicle battery, the vehicle controller communicates with the charging station controller via a cable with an electrical connector connected directly to the charging station or via an unlimited number of cascaded vehicles. At the same time, obtaining data on the electrical characteristics of the current for charging the vehicle power supply from the charging module controller makes it possible to dynamically adjust the characteristics of the supplied electric current for charging this particular power supply through other vehicles, thereby increasing the accuracy of determining the required electrical characteristics of the current and reducing the risk of vehicle failure, as well as providing an ability to operate the system offline.

Electrical characteristics conversion of the received current into those required for charging the vehicle battery in accordance with its electrical characteristics makes it possible to replenish the charge rate of the vehicle battery by using electric power supplied from the charging station. To this end, the charging module may comprise an electrical converter connected to the controller of the charging module and/or this may be provided by an electrical converter of the vehicle to which the charging module can be interfaced. This reduces the risk of failure for the charging station by using electronic components of the charging module or the vehicle on which it is installed (if any) to charge the battery. At the same time, in case of using electronic components of the vehicle for charging, the risk of failure for the charging module is also reduced.

The conversion of the electrical characteristics of the received current into those required for charging the vehicle's battery in accordance with its electrical characteristics will simultaneously ensure safe and fast charging of the vehicle battery, wherefore it must be provided in accordance with the characteristics of the vehicle's on-board network. Obtaining the data necessary for converting the electrical characteristics of the received current into those required for charging the vehicle battery can be provided by the controller from its internal memory in accordance with the obtained electrical characteristics of the vehicle battery. For this, in the internal memory of the controller can be contained a specialized algorithm for converting the electrical characteristics of the current received from the charging station into a current that is safe for charging the battery and for transmitting them to the built-in electrical converter or electrical converter of the vehicle through the interface, which improves the quality of the system and allows you to start charging the vehicle provided there is no wireless connection. Alternatively, the controller may be configured to send data on the electrical characteristics of the vehicle battery connected to it to the charging station controller and receive data necessary to convert the electrical characteristics of the received current by the electrical converter of the charging module or vehicle. Alternatively, the controller may be configured to request these data from a remote server through the wireless communication equipment of the charging module or the wireless communication equipment of the vehicle connected thereto via the charging module interface.

The means for receiving electrical energy is represented by a cable with an electrical connector, which makes it possible to simultaneously charge the batteries of electric vehicles with variable dimensions and connect them to the same charging station for electric vehicles of numerous types, as well as connect a non-electric vehicle and other objects equipped for the purpose of its organized storage and blockage. The electrical connector provides a mechanical connection and disconnection of the electrical circuit between the charging station and the vehicle battery or between two or more charging modules installed thereon. The electrical connector can also provide the ability to dock with the lock assemblies or with the vehicles themselves used for their organized storage. Besides, in case of connection with the locking gear units equipped with batteries, batteries can be configured to be charged through the electrical connector.

The electrical connector can be a male or female contact. The electrical connector may include an electrical connector controller processing signals from the charging module controller, thereby reducing the resource consumption of the charging module and improving its weight and size characteristics.

The electrical connector may include a locking mechanism, represented by a latch and a latch drive. The latch provides for the locking of the electrical connector in the means for transmitting electrical energy of the charging station or charging module and can be represented by a pin, a plug or a cylinder. In the most preferred embodiment, the lock is an inclined bolt. The latch drive is configured to unlock the electrical connector and can be electrical or mechanical. The latch actuator can be electrically connected to the charging module controller or the electrical connector controller and can be an electric motor or solenoid with a linkage system connected to the latch. At the same time, the connection of the locking mechanism with the controller of the electrical connector provides anti-vandal functions by eliminating the possibility to cut into a circuit the locking mechanism through the cable and activating the locking mechanism by a third-party energy source. Also, the locking mechanism may include equipment for forcible unlocking the electrical connector, represented by a key, button, or sensor element electrically connected to the controller of the electrical connector.

The charging module may comprise a tamper-evident sensor that provides the ability to notify of an unauthorized attempt to access the vehicle. The tampering sensor can be connected to an electrical connector controller or to a charging module controller for data transmission. The tamper sensor can be a destructible or non-destructible element that can be installed in the electrical connector. Also, the charging module may contain light indication elements that provide the ability to notify the user about the processes taking place in the controller of the charging module. Also for these purposes, the charging module may include an accelerometer.

The cable enables to transmit electrical energy from the charging station to the charging module or from one charging module to another charging module. For this, the cable is electrically connected on one side to the connector, and on the other side it is connected to the electronic components of the charging module—the controller of the charging module, and/or the electrical converter of the charging module, and/or the interface. In this case, the connection of the cable to the electronic components of the charging module can also be provided through an additional electrical connector installed at the opposite end of the cable from the main electrical connector. This arrangement provides the ability, if necessary, to disconnect the cable from the charging module and connect it, for example, to locking modules, charging stations, ensuring their easy replacement in case of failure or insufficient length and their independent functionality. The cable can be represented by one or more conductors in a shell. In this case, the cable may contain wire armor, presented in the form of a winding made of metal or fabric material, which reduces the risk of a cable defect and provides anti-vandal protection of the module. To improve the weight and size characteristics of the charging module, the cable can be made in the form of a spring coil, or the charging module can contain equipment for automatic cable winding. In this case, the cable can contain an additional wire, including an optical fiber, for data exchange with the charging station or other charging modules, or for this, wires can be used to transmit electric power.

The means for transmitting electrical energy to a battery of a third-party vehicle is configured to connect to the same charging module installed on one vehicle, another charging module for charging several batteries of vehicles from the same charging station. The means for transmitting electrical energy to the battery of a third-party electric vehicle can be represented by a plug, connector or socket configured to correspond to the electrical connector of the charging module. Also, the means for transmitting electrical energy can be represented by a cable with an electrical connector, which is used to generate electric power, or an additional cable with an electrical connector connected to the electronic components of the charging module. At the same time, in order to ensure the possibility of blocking the electrical connector, the means for transmitting electrical energy to the battery of a third-party vehicle may contain a locking gear corresponding to the lock pin of the locking mechanism of the electrical connector, thereby also blocking various battery cells of vehicles, which provides anti-vandal organized storage and issuance of vehicles as in need of recharging or without.

The charging module may include a housing configured to mount and protect its electronic components. In this case, the housing of the charging station and the charging module can be made of any known structural materials, including metal, plastic or composite materials.

The connection of the electronic components can be provided by any known communication and electrical connection equipment.

The family of inventions can be implemented using known equipment, materials and technologies, which indicates its compliance with the “industrial applicability” criterion of patentability.

The family of inventions is characterized by essential features previously unknown from the prior art, which consist in the following:—
the means for receiving electrical energy is represented by a cable with an electrical connector, configured to create a flexible coupling between charged electric vehicles, which makes it possible to include in a cascade charging circuit an electrical vehicle having variable heights, lengths, widths, as well as variable types of frames, and chassis at a time;
the charging module is configured to obtain electrical characteristics of the vehicle battery and convert the electrical characteristics of the received current into those required for charging the vehicle battery in accordance with its electrical characteristics, which makes it possible for the charging module to recognize the vehicle battery connected thereto, obtain electrical data characteristics, including the voltage of the on-board network and the type of vehicle batteries, determine by the charging module or charging station the required characteristics of the charging current, convert the current received from the charging station and charge the vehicle batteries with an electric current of the required characteristics, which makes it possible to connect to a circuit charging vehicle batteries with any electrical characteristics, as well as charging current.

Thus, the essential features of the family of inventions provide the possibility to include in the charging circuit vehicle batteries with variable overall characteristics, with variable types of frame and chassis, as well as with any electrical characteristics of the on-board network and the required charging current, thereby ensuring the achievement of the technical result consisting of in providing the possibility of simultaneous connection to the system for charging and subsequent simultaneous charging of variable types of batteries of numerous vehicles, thereby expanding the functionality and scope of the system for charging vehicle batteries.

The family of inventions is characterized by a set of essential features previously unknown from the prior art, which proves its compliance with the “novelty” criterion of patentability.

The set of essential features of the family of inventions is inextricably linked and ensures the achievement of a synergistic effect, which consists in creating a universal system for simultaneous connection of numerous vehicles thereto and subsequent charging the consumers of electrical energy installed thereon. The versatility of the system for charging is provided due to the use of a cable with an electrical connector in the charging module simultaneously with the possibility of obtaining the electrical characteristics of the vehicle battery and converting the electrical characteristics of the current into those required for charging the vehicle in accordance with its electrical characteristics, which together makes it possible to connect variable types of batteries for numerous types of transport in a chain and carry out their simultaneous charging. Also, with the help of the family of inventions, we can achieve the versatility and flexibility of the technical system, in which not only vehicles specially converted for this purpose, but also any vehicles equipped with charging or locking modules of compatible standards, can function. Separately, these features cannot provide such an effect, since if only a cable with an electrical connector in the charging module is applied it cannot provide the ability to connect the vehicle batteries with various electrical characteristics with no risk of their electronic damage, or it cannot provide the ability to charge the batteries of vehicles, but it can provide the ability to connect only vehicles with similar electrical characteristics. The same applies to the possibility to determine the electrical characteristics of the current for charging the vehicle batteries and convert the electrical characteristics of the current into those required for charging the vehicle, since if there is only a rigid connection between the vehicles, the variability of their chassis types, as well as their overall dimensions, are not provided. Thus, not a single feature separately can solve the problem of creating a universal system for simultaneous connection of variable batteries of numerous vehicles thereto and then charging them, regardless of the type, sort or shape of this vehicle or the type of batteries, which indicates that the claimed system, method and charging module comply with the “inventive level” criterion of patentability.

The family of inventions is illustrated by the following figures.

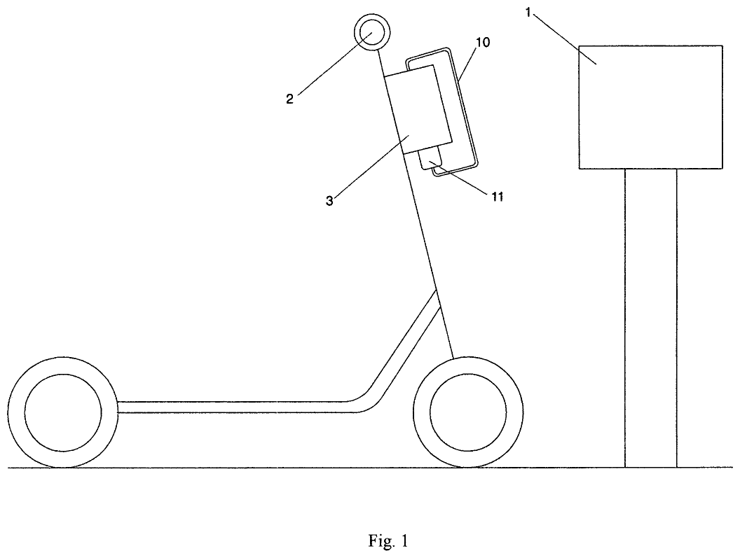

FIG. 1—The charging station and an electric scooter with the charging module installed thereon, general view.

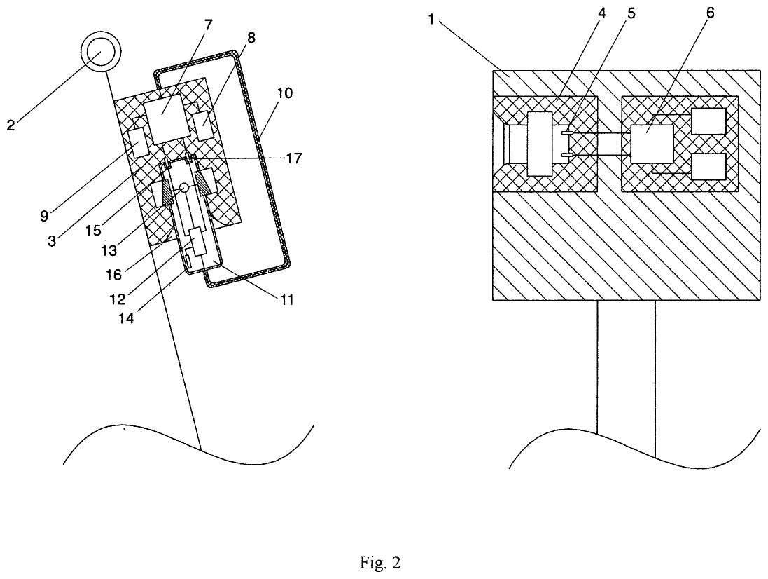

FIG. 2—The charging station and an electric scooter with the charging module installed thereon, longitudinal section.

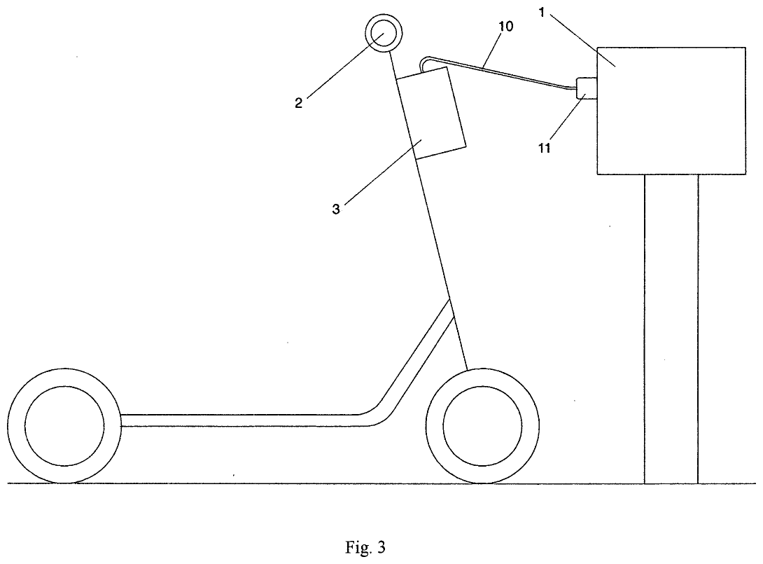

FIG. 3—The charging station and an electric scooter with the charging module installed thereon and connected to the charging station, general view.

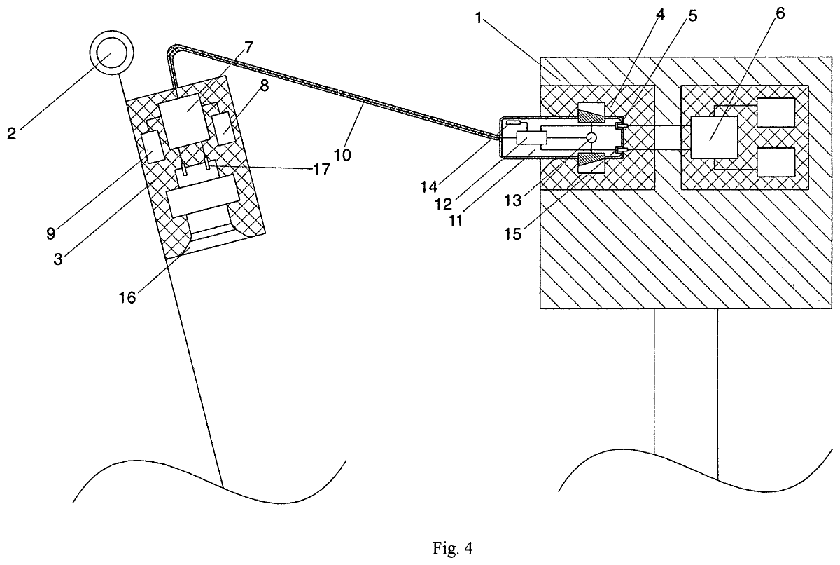

FIG. 4—The charging station and an electric scooter with the charging module installed thereon and connected to the charging station, longitudinal section.

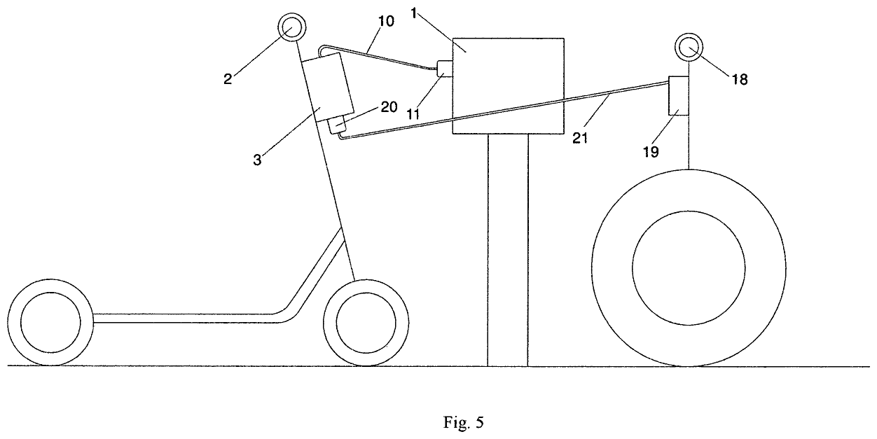

FIG. 5—The charging station and an electric scooter with the charging module installed thereon and connected to the charging station, and a Segway with the charging module connected to the charging module of an electric scooter, general view.

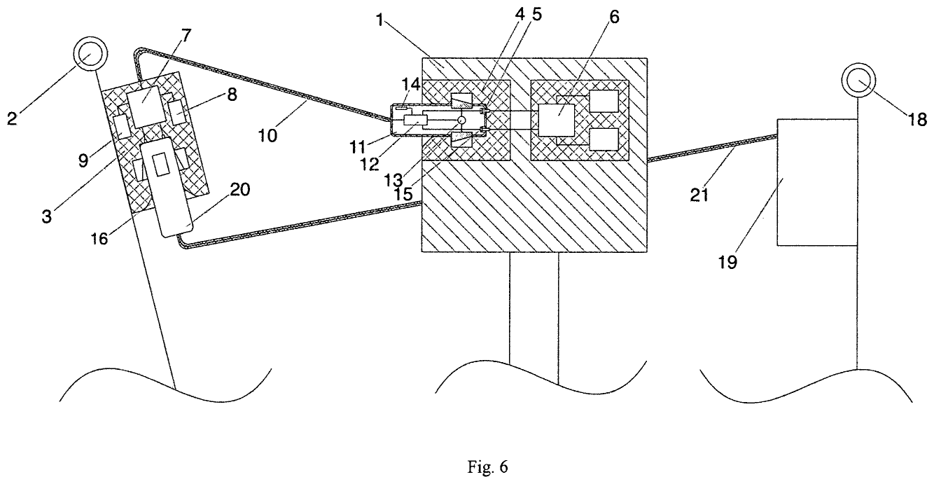

FIG. 6—The charging station and an electric scooter with the charging module installed thereon, connected to the charging station, and a “Segway” connected to the charging module of an electric scooter, longitudinal section.

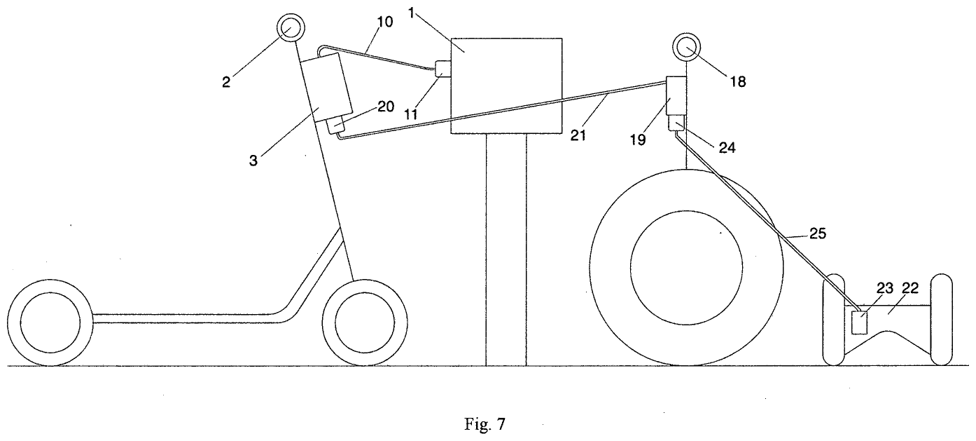

FIG. 7—A gyro scooter connected to the charging module of a “Segway by equipment of the charging module installed thereon, general view.

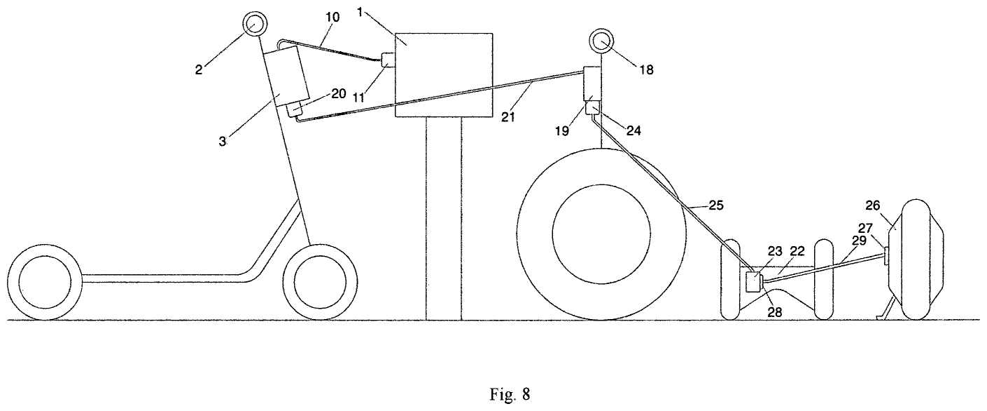

FIG. 8—a mono-wheel connected to the charging module of a gyroscooter by equipment of the charging module installed thereon, general view.

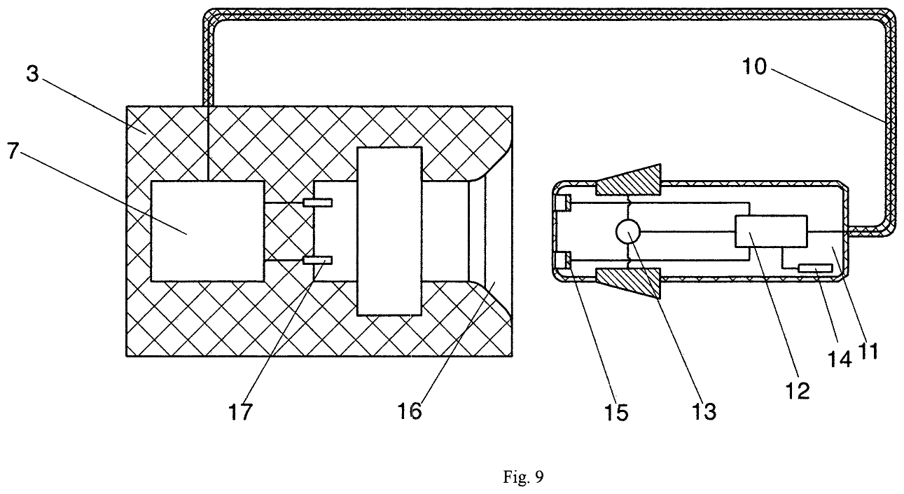

FIG. 9—The charging module of the system for charging, longitudinal section.

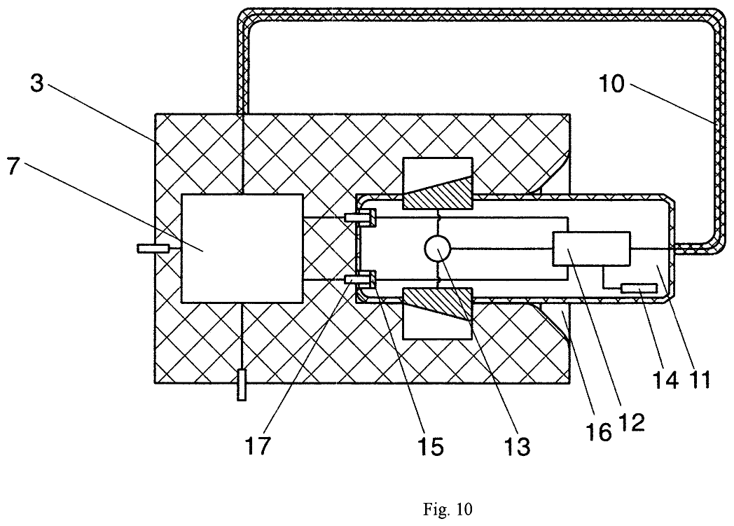

FIG. 10—The charging module of the system for charging with connectors to be connected to a GSM module and the current converter of an electric vehicle, longitudinal section.

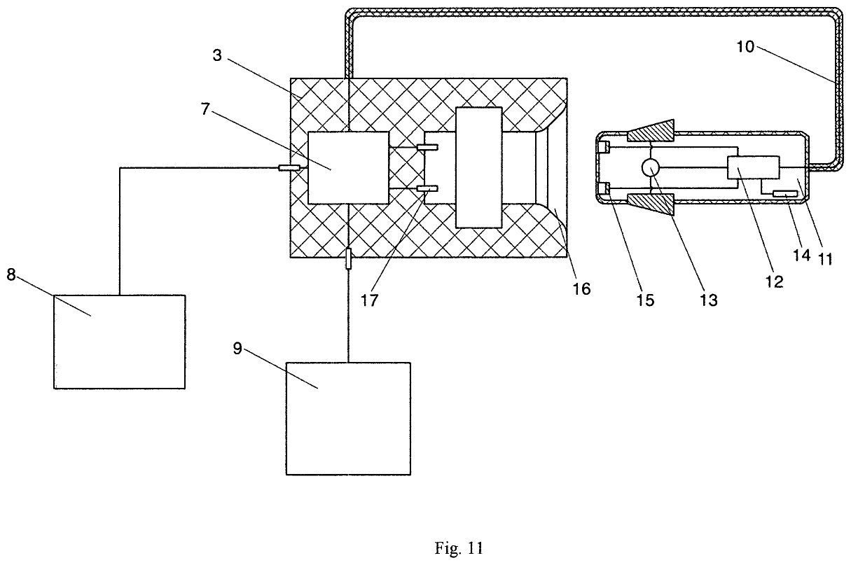

FIG. 11—The charging module of the system for charging connected to a GSM module and the current converter of an electric vehicle, longitudinal section.

To illustrate the possibility of implementation and more complete understanding of the concept of the family of inventions, an embodiment is presented below, which can be modified or supplemented in any way, while the present family of inventions is by no way limited to the presented embodiment.

The system for charging vehicles consist of the charging station 1 and the vehicle 2 of the “electric scooter” type with the charging module 3 installed thereon. The charging station 1 contains the socket 4 for transmitting electrical energy to a vehicle, which includes spring-loaded contacts 5. Also, the charging station includes the controller 6 and the electrical converter (not shown in the figures), electrically connected to each other.

The charging module 3 contains the controller 7 configured to obtain the electrical characteristics of the vehicle battery, the converter 8 of the characteristics of the current received from the charging station into the required current characteristics for charging the vehicle battery in accordance with the obtained electrical characteristics and in some versions of the GSM module 9 electrically connected to the controller 7. The charging module 3 contains the cable 10, at one end of which the electrical connector 11 is installed for receiving electric power, which contains the controller 12, the locking mechanism 13, the tamper sensor 14, which provides instant locking of the vehicle in the event of its destruction, and the contact elements 15 electrically connected to the controller 12, while the other end of the cable 10 is electrically connected to the controller 7, which is configured to be electrically connected to the on-board network of the vehicle via a wired or wireless interface (not shown in the figures) In some embodiments, the electrical connector 11 contains a mechanical or electrical button (not shown in the figures), which when it is pressed for additional protection against unauthorized access, can open the locking mechanism. Also, the charging module 3 contains the socket 16 (similar to socket 4) for charging the batteries of a third-party vehicle, which contains the spring-loaded contacts 17 (similar to spring-loaded contacts 5), electrically connected to the controller 7. In some versions, the charging module 3 contains an accelerometer (not shown in the figures), electrically connected to the controller 7, to ensure identification of acts of vandalism against the electric scooter 2.

The operation of the family of inventions is as follows.

A user, through a specialized application on his electronic device or by placing an electronic card to a card reader (not shown in the figures), will establish a connection with the charging station 1 directly or via the control server. After that, the controller 6 will send a signal to the controller 7 through the controller of the locking mechanism 13 to unlock the locking mechanism 13 (via button pressed or not). The user will remove the electrical connector 11 from the charging station and attach it to the socket 16 of the charging module. Without this step, the vehicle 2 will not start moving. In this case, while the vehicle 2 is moving, the electrical connector 11 is blocked in the socket 16 of the charging module. After completion of the operation of the electric scooter 2, the electrical connector 11 is removed from the socket 16 of the charging module and inserted into the socket 4 of the charging station.

After that, the controller 7 will exchange data with a control unit (not shown in the figures) of the electric scooter 2 and receive data on the voltage of the on-board network, the type and capacity of the batteries, as well as the rate of their current charge. Taking into account that the voltage of the on-board network of the electric scooter is 6 V, the battery capacity is 16 A*h, and the current charge rate is 20%, the controller 7 will determine the required current characteristics for charging the batteries of the electric scooter 2, which consists in setting the charging voltage not higher than 6 V, and the charging current is in the range from 15 to 1 A, depending on the technical capabilities of the charging station and the charge rate of the batteries of the electric scooter 2. In this case, the electric current for charging the batteries of the electric scooter 2 flows through the electrical connector 11 and cable 10 to the converter 8, converts to the required characteristics and goes to the batteries of the electric scooter 2.

After the end of the operation of the Segway-type vehicle 18, equipped with the charging module 19, the user will attach the electrical connector 20 with the cable 21 to the socket 16 (electric scooter 2) with the charging module 3. The controller of the charging module 19 contains data on the electrical characteristics of the vehicle batteries 18, including data on current voltage, capacity and charge rate. The controller of the charging module 19 transmits the data to the controller 6 of the charging station, which in turn transmits data from the internal memory of the controller 6 to convert the electrical characteristics of the current received from the charging station into those required for charging the Segway batteries. Taking into account that the voltage of the on-board network of the vehicle 18 is 10 V, the battery capacity is 40 A*h, and the current charge rate is 65%, the controller 6 determines the required characteristics of the current for charging according to a specialized algorithm, which consists in setting the charging voltage not higher than 10 V, charging current—in the range from 15 to 1 A, depending on the technical capabilities of the charging station and the increase in the charge rate of the Segway power cells. The controller of the charging module 19 will send a command to its converter to set the characteristics of the current received from the charging station to the required characteristics for charging the Segway batteries 18. The charging current will be supplied from the station 1 via the cables 10 and 21 to the charging module 19, where it will be converted to the required value, after which it will be fed to the Segway 18 batteries. At this time, data are exchanged between the controller of the charging module 19 and the controller 6 of the charging station via the cables 21 and 10, and when the programmed charge rate of the Segway 18 battery is registered, which is 75%, the controller 6 can send a command to turn off the charging of the Segway battery 18 and to continue charging the battery of the electric scooter 2 with the required charging current characteristics or to continue charging both vehicles if the technical capabilities of the charging station are sufficient to charge all vehicles connected thereto.

After the end of operation of the vehicle 22 of the “gyro scooter” type, equipped with the charging module 23, the user installs the electrical connector 24 with the cable 25 in the socket (not shown in the figures) of the charging module 19. In this case, the controller of the charging module 23 contains the electrical characteristics of the battery of the gyro scooter 22. Taking into account that the voltage of the on-board network of the gyro scooter 22 is 9 V, the battery capacity is 20 A*h, and the current charge rate is 40% the controller 6 of the charging station 1, by requesting data on the remote server, will determine the required current characteristics for charging the battery of the scooter 22, consisting in setting the charging voltage is not higher than 9 V, and the charging current is in the range from 15 to 1 A, depending on the increase in the charge rate of the battery. The controller 6 transmits data to the controller of the charging module 23, which sends a command to its converter to set the characteristics of the current received from the charging station to the required characteristics for charging the battery of the scooter 22 in accordance with the received data. At this time, data are exchanged between the controller of the charging module 23 and the controller 6 of the charging station via the cables 25, 21 and 10. At the same time, the controller 6 of the charging station will continue charging the vehicles 18 and 2 or stop charging them and completely transfer all power to the charging of the vehicle 22 in accordance with the internal algorithm, according to which the charge preference is given to the battery of the last vehicle in the network. When it reaches a certain level, the controller 6 will make a decision on the simultaneous charging of the previous vehicles all together or separately. In this case, when the charge rate of the battery of the gyro scooter 22 is 75%, the controller 6 will send a command to the charging module 23 to turn off the charging of the battery of the gyro scooter 22, and the charging current will switch to the charging module 3 of the electric scooter 2 or the charging module 19 of the vehicle 18 in accordance with the algorithm or special command from the server.

After the end of operation of the “mono-wheel” type vehicle 26, equipped with the charging module 27, the user will attach the electrical connector 28 with the cable 29 to the outlet (not shown in the figures) of the charging module 23. In this case, the controller of the charging module 27 will determine the electrical characteristics of the mono-wheel battery 26. Taking into account that the voltage of the on-board network of the mono-wheel 26 is 12 V, the battery capacity is 12 A*h, and the current charge rate is 55%, the controller of the charging module 27 communicates via the GSM module of this charging module with the remote server and receives the necessary current characteristics for charging the battery of the mono-wheel 26, consisting in setting the charging voltage not higher than 12 V, and the charging current in the range from 5 to 1 A, depending on the increase in the battery charge rate. The controller of the charging module 27 will send a command to its converter to set the characteristics of the current received from the charging station to the required characteristics for charging the battery of the mono-wheel 26, and then the controller 6 will charge this vehicle simultaneously with the previous ones or in any other combination in accordance with an algorithm. For example, if vehicles 18 and 22 are already charged to 75%, vehicle 26 to 70% and vehicle 2 to 20%, then the controller 6 can command vehicles 2 and 26 to charge simultaneously and shut off the vehicles 18 and 22.

At this time, data are exchanged between the controller of the charging module 27 and the controller 6 of the charging station via cables the 29, 25, 21 and 10, and when the charge rate of the mono-wheel battery 26 reaches 75%, the controller 6 will send a command to disconnect the charging of its battery and to continue charging the battery of the electric scooter 2 with the required charging current characteristics. When the charge rate of the batteries of all vehicles reaches 75%, the batteries of all vehicles in the chain are charged to 100%, wherefore a command is sent to charge the mono-wheel 26 to the controller of the charging module 23, and then to the controller of the charging module 19 to charge the gyro scooter 22, after which—to the controller 7 of the charging module 3 to charge the Segway 18, after which the electric scooter 2 is fully charged from the charging station 1. This is due to the fact that the charging speed of the batteries of a completely discharged vehicle up to a rate of 75% occurs for the same period of time as a full charge of the batteries from 75 to 100%. Likewise, the charging module is connected to the “mono-wheel”, to which an electronic locking device mounted on a non-electric bicycle (not shown in the figures) is connected, as well as a headlight and taillight of this bicycle, equipped with rechargeable batteries. Taking into account that the battery voltage of the locking device is 3.7 V, the battery capacity is 0.2 A*h, and the current charge rate is 15%, the charging module controller automatically sets the voltage on the converter to no higher than 3.7 V, and the charging current is 1 A. Since the charging station will transmit data about the availability of electrical contact between the charging modules of the vehicles 2, 18, 22 and 26 in the chain, and the charging module will transmit data to the remote server about the termination of electrical contact between the charging modules, while the charging module from which the data on the termination of electrical contact with the rest of the modules are sent will wait for confirmation from the remote server about the renewal of electrical contact between the charging modules of the vehicles in the chain and then will send a permit to operate the vehicle, then, if necessary, the user will receive the vehicle, for example 18 located in the charging circuit, he/she will be required to remove the electrical connectors 20 and 24 and attach the electrical connector 24 to the socket 16, and the electrical connector 20 to the socket of the charging module 19. Otherwise, the controller of the charging module 19 will not give permission to start the vehicle's engine 18. The charging station 1, and also vehicle 22 will signal the need to connect them. In this case, the charging module of the vehicle 18 will receive a start command only after receiving a signal from the server, which has received data from the charging station 1 that the vehicles are connected to the charging circuit. In this case, if this charging circuit is not closed with the charging station 1, the operation of the vehicle is not allowed. When an attempt is made to cut the wires 10, 21, 25 or 29 by the corresponding charging module, an unauthorized termination of contact with another charging module is registered and the vehicle on which this charging module is installed is electrically blocked.

Also, one of the options for using the charging module and the means (equipment) for transmitting electrical energy can be the organization of the storage of vehicles in such a way that the cable with the electrical connector wraps around a fixed obstacle (bracket, pipe, pole, similar amenities) and is installed in the socket of the same charging module.

Also, one of the embodiments of the invention may be the case when the charging station 1 may not have a connection to the centralized power grid, while the power of the controller 6 of the charging station can be provided from the vehicle 2 by transmitting electrical energy through the electrical connector, recognizing by the vehicle of the unique number of the charging station 1, connecting the charging module to the remote server and communicating the unique number of the charging station to the remote server. In a similar way, other vehicles are connected through their charging modules, but at the same time they are not charged from the charging station, and only centralized storage is provided. At the same time, the residual electricity from the vehicles is used for the operation of the controller 6, which makes it possible to complete the rent in automatic mode without any need to use the user's electronic devices.

Thus, the possibility of simultaneous connection and subsequent simultaneous charging of variable types of power supply elements (batteries) of numerous vehicles is ensured, thereby expanding the functionality and scope of the system for charging the batteries of vehicles.

1. A system for charging vehicles, comprising: a charging station and a vehicle, where the charging station includes means for transmitting electrical energy to a vehicle battery, and the vehicle includes a charging module, provided with means for receiving electrical energy and the means for transmitting electrical energy to said battery, wherein the means for receiving electrical energy of the charging module are represented with a cable with power connector, and said charging station or charging module is configured to obtain vehicle battery electrical characteristics and to convert electrical characteristics of the current received into those required for charging the batteries of said vehicle in accordance with its electrical specifications.

2. The system according to claim 1, wherein the charging station includes a controller configured to obtain data on vehicle battery charge level from the charge modules, and each charging module is configured to activate a channel for building up a closed loop between the charging station and other charging module, providing an opportunity for individual charging of vehicle batteries in said system.

3. The system according to claim 1, wherein the means for transmitting electrical energy to said vehicle batteries are configured with a socket corresponding to the charge module cable with said electrical connector.

4. The system according to claim 3, wherein the socket of said charging station includes a locking element for charging.

5. A charging module of a vehicle provided with means for receiving electrical energy and means for transmitting electrical energy to batteries of third party vehicle wherein the means for receiving electrical energy are represented with the cable with the electrical connector, and the charging module is configured to obtain data on electrical characteristics of said vehicle batteries and to convert electrical characteristics of the current received in those required for the charge of said vehicle batteries in accordance with its electrical characteristics.

6. The charging module according to claim 5, wherein the module comprises a controller and interface to obtain data on electrical characteristics of the current for the charge of said vehicle batteries, and an electric energy converter to convert current characteristics in those required for the charge of the vehicle batteries.

7. The charging module according to claim 6, wherein the electrical connecter for connecting to an electric terminal of the charging station includes locking gear.

8. The charging module according to claim 7, wherein the means for transmitting electrical energy to said batteries of the third party vehicle include a socket configured to correspond to said charging module electrical connector.

9. The charging module according to claim 8, wherein said socket comprises a locking gear corresponding to a holder of said electrical connector.

10. The charging module according to claim 9, wherein said electrical connector includes a controller connected with the one of the charging module and said locking gear has a holder and a drive of said holder connected to said electrical connector controller.

11. The charging module according to claim 10, wherein the electrical connector is provided with a tamper sensor connected to the electrical connector controller.

12. A method for charging vehicles comprising: transmittance of electrical energy by said charging station to said vehicle batteries through said means for transmitting charging station electrical energy, reception by said charging module electrical energy from said charging station through said means for receiving vehicle charging module electrical energy and subsequent transmittance of received electrical energy by said charging module to said batteries of said third party electrical vehicle through said means for receiving electrical energy from third party vehicle charging module connected to its means for transmitting electrical energy, wherein said electrical energy is received by said charging module via said cable with said electrical connector, where said charging module obtains electrical characteristics of vehicle batteries components and converts electrical characteristics of received current in those required for the charge of said vehicle batteries in accordance with its electrical characteristics.

13. The method according to claim 12, wherein electrical energy from the charging module is transmitted in parallel with all charging modules connected in series.

14. The method according to claim 12, wherein the socket with the locking gear corresponding to said electrical connector on said cable is used as means for transmitting electrical energy of the charging station.

15. The method according to claim 14, wherein the locking gear of the electrical connector on command from said electrical connector controller disables said electrical connector in said socket, which eliminates an opportunity to activate said locking gear by using third party power-supply source.

16. The method according to claim 12, wherein the charging station receives data on charge level for all connected vehicles when electrical vehicle is connected to a charging circuit.

17. The method according to claim 16, wherein electrical energy is transmitted from the charging station to the last charging module connected to said charging circuit.

18. The method according to claim 17, wherein electrical energy is transmitted from the charging station until the last connected vehicle batteries reach charge level corresponding to the rate specified by the program.

19. The method according to claim 18, wherein after the programmed charge rate of said batteries is reached, electrical energy is transmitted to said vehicles, the charge rate of batteries of which is less than the programmed charge rate.

20. The method according to claim 12, wherein said vehicles will not be enabled by the charging module till after its internal circuit closing, which is executed via mounting the electrical connecter into means for transmitting electrical energy to a third party vehicle.

21.-25. (canceled)
